(19) United States
(12) Patent Application Publication
(10) Pub. No.: US 2002/0091922 A1
(43) Pub. Date: Jul. 11, 2002

(54) Architecture for a unified synchronous and asynchronous sealed transaction

(75) Inventors: Theodore Jack London Shrader, Austin, TX (US); Randy Scott Humphrey, Austin, TX (US); Davis Kent Soper, Cedar Park, TX (US); Xiaoyan Zhang, Austin, TX (US)

Correspondence Address: Darcell Walker, 8107 Carvel Lane, Houston, TX, 77036, US

(73) Assignee: INTERNATIONAL BUSINESS MACHINES CORPORATION, ARMONK, NY (US)

(21) Appl. No.: 09/750,255

(22) Filed: Dec. 28, 2000

(51) Int. Cl. H04L 9/32

(52) U.S. Cl. 713/157

(57) ABSTRACT

The present invention allows multiple stops in a complete transmission and retains the history and integrity of the stops, as well as any modifications made by the stop point along the way. The invention works whether the transmission consists of synchronous or asynchronous protocols. The invention is specifically designed to operate when both protocols are present in the same transmission. The invention keeps a history of the stop by chaining SignedData objects together and using the related message digest signed attribute for the linkages. This ability to blend two different protocols is not available in other transmission techniques involving only one hop between entities. The technique of the invention retains the original identity and signature of the original sender, as well as the integrity of the original message.

### FIELD OF THE INVENTION

This invention relates to transmitting information over a global computer network and in particular to an architecture and method for transmitting sealed information across multiple synchronous and asynchronous protocols over the global computer network.

### BACKGROUND OF THE INVENTION

The expansion of computer networks and the advancements in information technology have attached a growing number of persons and companies to conduct business over the computing networks. This practice has substantially increased the number of message transmissions. These message transmissions occur over communication mediums use one of two communication protocols: synchronous or asynchronous. Synchronous communication protocols are seen in point-to-point communications. These transactions involve at least two entities in direct contact with each other such as a telephone conversation or facsimile transmission. These transactions occur over a secure line with minimum risk of compromising any confidential information that may be transmitted during the transaction. One example of a synchronous protocol is Secure Sockets Layer (SSL). The other communication protocol type is asynchronous. With this protocol type, there is no direct connection between entities. Transmissions over a global computer network such as the Internet are not point-to-point. In fact, a message may have traveled through several entities before reaching its final destination. An example of this protocol is a typical electronic mail transmission. These communication protocols use encryption techniques and other procedures to ensure the security, authentication and integrity the of message transmissions. One area of encryption techniques use keys to authenticate and validate transmitted messages.

One type of encryption, Symmetric, or private key, encryption (also known as conventional encryption) is based on a secret key that is shared by both communicating parties. The sending party uses the secret key as part of the mathematical operation to encrypt (or encipher) plaintext to ciphertext. The receiving party uses the same secret key to decrypt (or decipher) the ciphertext to plaintext. Examples of symmetric encryption schemes are the RSA RC4 algorithm (which provides the basis for Microsoft Point-to-Point Encryption (MPPE), Data Encryption Standard (DES), the International Data Encryption Algorithm (IDEA), and the Skipjack encryption technology proposed by the U.S. government (and implemented in the Clipper chip).

With symmetric encryption, both the sender and receiver have a shared secret key. The distribution of the secret key must occur (with adequate protection) prior to any encrypted communication. However, with asymmetric encryption, the sender uses the recipient's public key to encrypt or digitally sign messages, while the receiver uses their key to decipher these messages. The public key can be freely distributed to anyone who needs to encrypt messages to the owner of the public key or to verify digitally signed messages by the private key that corresponds to the public key. The owner of the key pair only needs to carefully protect the private key.

Another encryption technique, asymmetric or public key encryption uses two different keys for each user: one key is a private key known only to the user to which the key pair belongs; the other is a corresponding public key, which is accessible to anyone. The encryption algorithm mathematically relates the private and public keys. One key is used for encryption and the other for decryption, depending on the nature of the communication service being implemented. The public key is made public by distributing it widely. The private key is never distributed; it is always kept secret. In addition, public key encryption technologies allow digital signatures to be placed on messages. A digital signature uses the sender's private key to encrypt some portion of the message. When the message is received, the receiver uses the sender's public key to decipher the digital signature as a way to verify the sender's identity and the integrity of the message.

To secure the integrity of the public key, the public key is published with a certificate. A certificate (or public key certificate) is a data structure that is digitally signed by a certificate authority (CA). The CA is an authority that users of the certificate can trust. The certificate contains a series of values, such as the certificate name and usage, information identifying the owner of the public key, the public key itself, an expiration date, and the name of the certificate authority. The CA uses its private key to sign the certificate. If the receiver knows the public key of the certificate authority, the receiver can verify that the certificate is indeed from the trusted CA, and therefore contains reliable information and a valid public key. Certificates can be distributed electronically (via Web access or e-mail), on smart cards, or in an LDAP database. Public key certificates provide a convenient, reliable method for verifying the identity of a sender. IPSec can optionally use this method for end-to-end authentication.

A public and private key pair is a unique association of key values wherein one key can encrypt information and the other can decrypt. For example, the public key can encrypt data and only the corresponding private key can decrypt the data. Public and private keys are used for signing and sending encrypted messages. A public key is typically made available to users on a global computer network (the Internet) within a certificate stored in a publicly accessible Lightweight Directory Application Protocol (LDAP) directory. The associated private key is kept in confidence by the entity, such as Is the person or cooperation that owns the key pair.

Although a message is encrypted to make it private, there is still a concern that someone might modify the original message or substitute it with a different message. One way to guaranteeing the integrity of the original message is to create a concise summary of the message and send this summary along with the message to the receiving party. Upon receipt of the message, the recipient creates its own summary and compares it with the one sent. If the message summaries agree, then the message was received intact. This message summary is called a message digest, or one-way hash. Message digests are used to create short, fixed-length representations of longer variable-length messages. Digest algorithms are designed to produce unique digests for different messages. Message digest are designed to make it too difficult to determine the main message from the digest and also impossible to find two different messages which create the same digest. This trait of a message digest eliminates the possibility of substituting one message for another while maintaining the same digest.

When one entity sends a message to another entity, the receiving entity needs to ensure that the message is really from the sender, so an intruder does not interfere with or alter that message. A digital signature, created by the sending entity and included with the message serves this purpose. Digital signatures are created by encrypting a digest of the message, and other information (such as a sequence number) with the sender's private key. Though anyone may decrypt the signature using the public key, only the signer knows the private key. This means that only they may have signed the message. Including the digest in the signature means the signature is only good for that message; The digital signature also ensures the integrity of the message since no one can change the digest and still sign it. To guard against interception and reuse of the signature by an intruder at a later date, the signature contains a unique sequence number. This protects against a fraudulent claim by the sender that they did not send the message.

The Secure Sockets Layer protocol (SSL) is a protocol layer which may be placed between a reliable connection-oriented network layer protocol (e.g. TCP/IP) and the application protocol layer (e.g. HTTP). SSL provides for secure communication between client and server by allowing mutual authentication, the use of digital signatures for integrity, and encryption for privacy. The protocol is designed to support a range of choices for specific algorithms used for cryptography, digests and signatures. These choices allow algorithm selection for specific servers to be made based on legal, export or other concerns, and also enables the protocol to take advantage of new algorithms. Choices are negotiated between client and server at the start of establishing a protocol session. Many users and developers typically utilize the SSL or Transport Layer Security (TLS) standards to handle secure synchronous transactions over the Internet. For example, SSL helps establish the identity of the server and client before generating a unique secret key to exchange confidential information between the two entities. Users and developers also utilize the Secure/Multipurpose Internet Mail Extensions (S/MIME) standard to handle secure asynchronous transactions between parties, such as with signing or encrypting a message.

Previous communication protocols have focused on transmission of a sealed transaction between two entities. In a typical SSL transaction such as sending a facsimile message, the destination can perform processing on the information and determine its origin and maintain the originality of the message. The recipient will know what entities were involved in the transaction along the transmission, the actual sender of the message, check to verify that each entity was able to sign that information confirming that they were able to take care of the information. An example is purchasing an item over the Internet. This type of transaction is an SSL transaction. However, sending an electronic mail message is an asynchronous transaction. With the expanded use of the Internet and other computing networks, there is a need to be able to have the ability to trace events in the transmission of the message regardless of whether the transmission is synchronous or asynchronous.

### SUMMARY OF THE INVENTION

It is an object of the present invention to provide a communication procedure that can enable secure transmissions across multiple synchronous and asynchronous protocols.

It is another object of the invention to provide a procedure that will enable the recipient of a message to trace all of the events during the message's transmission.

It is another object of the invention to provide a means to store all events of a message transmission.

It is another object of this invention to provide a mechanism that can enable a transaction to span multiple synchronous and asynchronous secure transmissions using public key technologies.

This invention describes a method and architecture to seal a transaction across multiple synchronous and asynchronous protocols over a global computer network using public key and private key technologies. Protocols across global computer networks are available between two entities, such as a client and server, but they are limited in their ability to span multiple entities or hops, while still retaining the identity and original transaction of the initial sender in a standard fashion. In addition to ensuring the security of the transaction, this design addresses a unified transaction that is sealed and can span any combination of synchronous and asynchronous transmissions between multiple entities.

This invention allows any number of entities to participate in the sealed transaction, wherein each entity can add to the transaction, the complete transaction is protected from unintended recipients, and authentication and integrity is ensured with each entity. During the transmission, an entity may receive the transmitted message. The entity may add information or modify information in the message. The changes would be recorded in a data structure called a SignedData object. Each new entity that receives the message during the transmission may add a SignedData object to the transmitted. Through the SignedData objects, at the end of the transmission, there is a complete record of the events that occurred during the transmission of that message. In this method, the authenticity and integrity of the transaction is preserved.

### DESCRIPTION OF THE DRAWINGS

FIG. 1 depicts data processing equipment a system that can be utilized to implement the present invention;

FIG. 2 is a diagram of a computer over which messages may be transmitted synchronously or asynchronously;

FIG. 3 is a flow diagram of the steps in the implementation of the message transmission mechanism of the present invention;

FIG. 4 is a diagram of a data structure containing information in the transmitted message; and

FIG. 5 is a diagram of the signed attribute contained in the data structure.

### DETAILED DESCRIPTION OF THE INVENTION

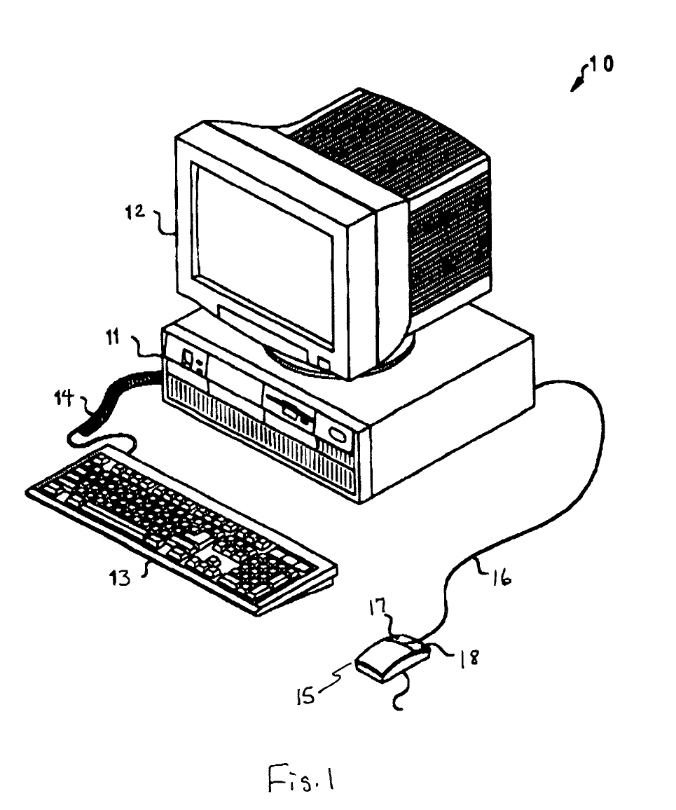

With reference now to FIG. 1, there is depicted a pictorial representation of data processing system 10 which may be used in implementation of the present invention. As may be seen, data processing system 10 includes processor 11 that preferably includes a graphics processor, memory device and central processor (not shown). Coupled to processor 11 is video display 12 which may be implemented utilizing either a color or monochromatic monitor, in a manner well known in the art. Also coupled to processor 11 is keyboard 13. Keyboard 13 preferably comprises a standard computer keyboard, which is coupled to the processor by means of cable 14. Also coupled to processor 11 is a graphical pointing device, such as mouse 15. Mouse 15 is coupled to processor 11, in a manner well known in the art, via cable 16. As is shown, mouse 15 may include left button 17, and right button 18, each of which may be depressed, or “clicked”, to provide command and control signals to data processing system 10. While the disclosed embodiment of the present invention utilizes a mouse, those skilled in the art will appreciate that any graphical pointing device such as a light pen or touch sensitive screen may be utilized to implement the method and apparatus of the present invention. Upon reference to the foregoing, those skilled in the art will appreciate that data processing system 10 may be implemented utilizing a personal computer.

The method of the present invention may be implemented in a global computer network environment such as the Internet. With reference now FIG. 1b, there is depicted a pictorial representation of a distributed computer network environment 20 in which one may implement the method and system of the present invention. This diagram illustrates the types of components through which sensitive and confidential; voting information may be exposed and the need for extreme security in this voting process. As may be seen, distributed data processing system 20 may include a plurality of networks, such as Local Area Networks (LAN) 21 and 22, each of which preferably includes a plurality of individual computers 23 and 24, respectively. Of course, those skilled in the art will appreciate that a plurality of Intelligent Work Stations (IWS) coupled to a host processor may be utilized for each such network. Any of the processing systems may also be connected to the Internet as Shown. As is common in such data processing systems, each individual computer may be coupled to a storage device 25 and/or a printer/output device 26. One or more such storage devices 25 may be utilized, in accordance with the method of the present invention, to store the various data objects or documents which may be periodically accessed and processed by a user within distributed data processing system 20, in accordance with the method and system of the present invention. In a manner well known in the prior art, each such data processing procedure or document may be stored within a storage device 25 which is associated with a Resource Manager or Library Service, which is responsible for maintaining and updating all resource objects associated therewith.

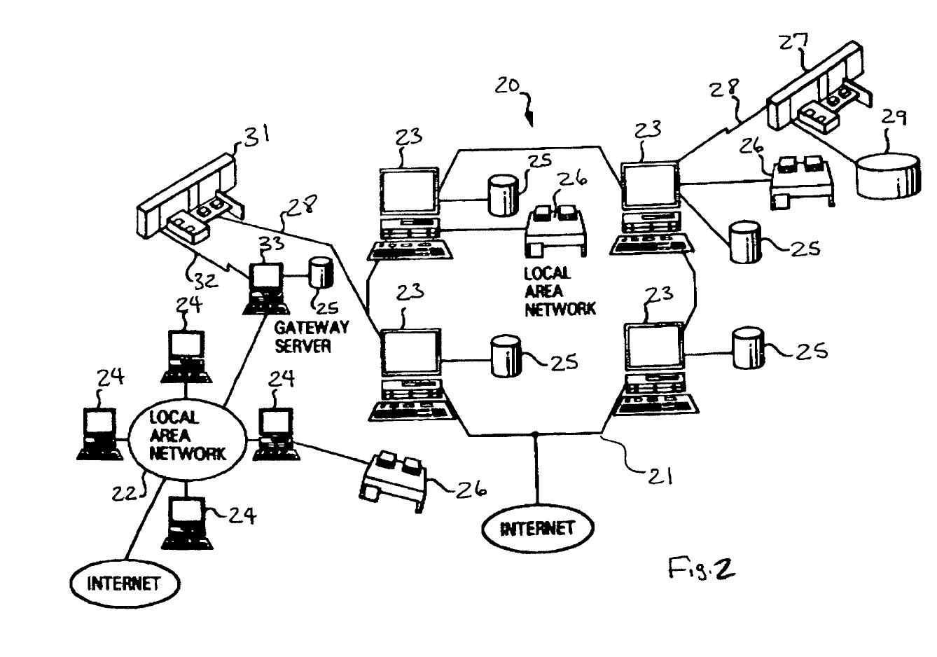

Still referring to FIG. 2, it may be seen that distributed data processing system 20 may also include multiple mainframe computers, such as mainframe computer 27, which may be preferably coupled to Local Area Network (LAN) 21 by means of communications link 28. Mainframe computer 27 may also be coupled to a storage device 29 which may serve as remote storage for Local Area Network (LAN) 21. A second Local Area Network (LAN) 22 may be coupled to Local Area Network (LAN) 21 via communications controller 31 and communications link 32 to a gateway server 33. Gateway server 33 is preferably an individual computer or Intelligent Work Station (IWS) which serves to link Local Area Network (LAN) 22 to Local Area Network (LAN) 21. As discussed above with respect to Local Area Network (LAN) 22 and Local Area Network (LAN) 21, a plurality of data processing procedures or documents may be stored within storage device 29 and controlled by mainframe computer 27, as Resource Manager or Library Service for the data processing procedures and documents thus stored. Of course, those skilled in the art will appreciate that mainframe computer 27 may be located a great geographical distance from Local Area Network (LAN) 21 and similarly Local Area Network (LAN) 21 may be located a substantial distance from Local Area Network (LAN) 24. That is, Local Area Network (LAN) 24 may be located in California while Local Area Network (LAN) 21 may be located within Texas and mainframe computer 27 may be located in New York.

This invention utilizes public and private key pairs for each party entity in the sealed transaction. A public and private key pair is a unique association of key values wherein one key can encrypt information and the other can decrypt. For example, the public key can encrypt the data and the corresponding private key can decrypt the encrypted data. Public and private keys are used for signing and sending encrypted messages. A public key is typically made available to users on the Internet within a certificate stored in a publicly assessable LDAP directory. The associated private key is kept in confidence by the entity, such as the person or corporation who owns the key pair.

Sealing the transaction involved signing the transaction with the sender's private key and encrypting the transaction with the recipient's public key. This process can also involve secret keys to help encrypt and decrypt bulk data. The sealed transaction is available to the recipient involved in the transaction, but not to unintended recipients. A sealed transaction meets the authentication, integrity, and confidentiality security requirements. This invention uses public key technologies to bring together the two different types of protocols and is applicable to current standards, as well as general synchronous and asynchronous transmissions.

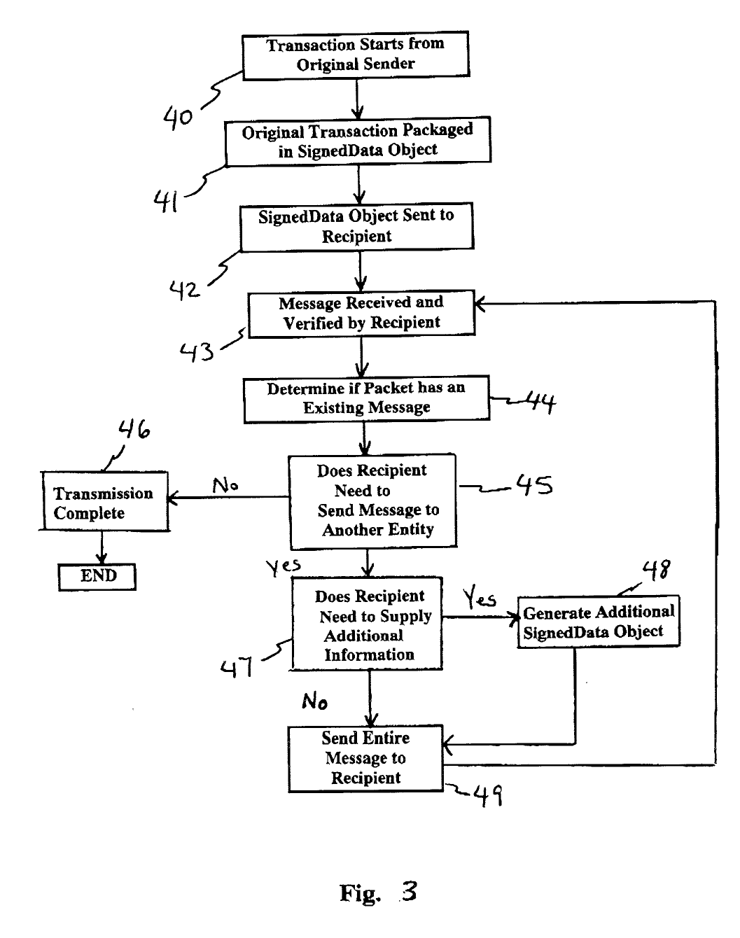

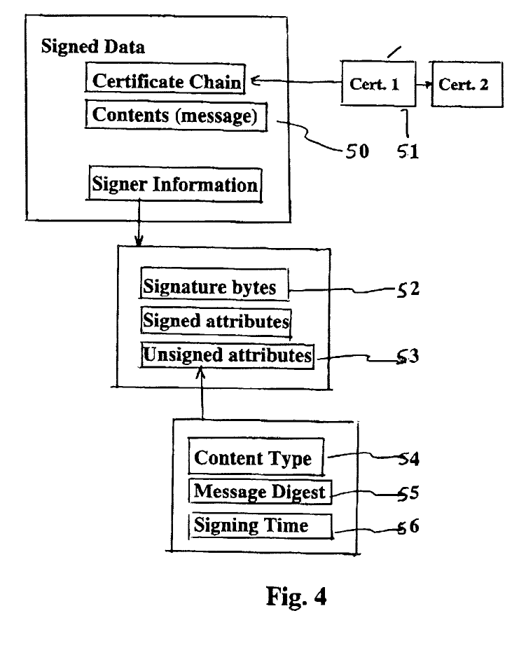

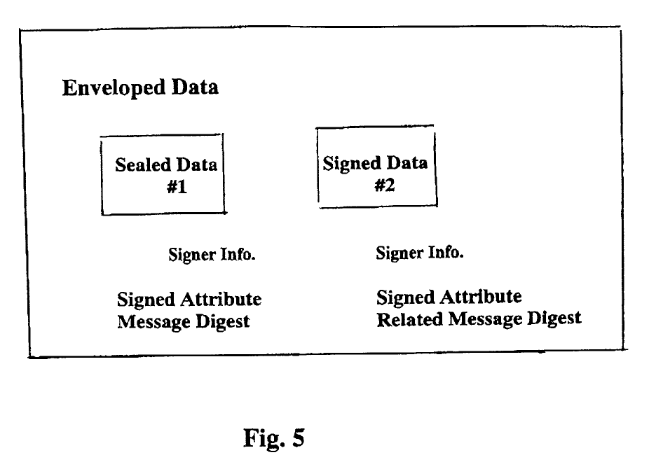

Referring to FIG. 3, the message transmission using the present invention starts from a client 40. If the message or transaction starts from a client to a server using a synchronous protocol, this design will package the original transaction within a Public Key Cryptology Standard (PKCS) SignedData object 41 (The preferred PKCS being standard number 7). The SignedData object, as shown in FIG. 4 is a data structure with various fields that can link to other data structures. The SignedData object consists of the original message 50, signing certificate 51, signature bytes 52, and signed attributes 53. The signed attributes, shown in FIGS. 4 and 5, consist of the content or data type of the message 54, message digest 55, and signing time 56. Referring to FIG. 3, the SignedData object is sent to a receiver entity 42. Recipients of a SignedData object can verify the message and signature 43 using the sender's public key to ensure the authenticity of the sender and integrity of the message. The Recipient has to determine if the sender already has an existing message, which means the sender was a receiver of a previous transaction 44. If the recipient does not need to forward the message to another entity 46, the message transmission ends. When the sender does have an existing message, Recipient has to decide whether to continue to send the message or is this Recipient the final destination 45. If the message requires that the sender needs to continue sending the message on to another entity 45, the sender can generate add additional information 47 to the message. This additional information can include information such as an update to the transaction within a new SignedData object 48. The new SignedData object will have a new message (potentially), certificate of the current sender, signature bytes generated from the current sender's private key, and new signed attributes. The signed attributes will consist of the data type of the new message, the message digest of the new message, the signing time, and the message digest of the old message. This last signed attribute is known as the related message digest. Since message digest values are unique to the message for which the digest was generated, the related message digest attribute value allows the final or interim recipients to link the messages together to form the original chain of messages and determine the initial sender. (Optionally, the recipient can also use the signing time attribute to assist in the chronological ordering of the messages. However, there may be time drift between the entities that may make the signing time values unreliable.) All of the SignedData objects are grouped together and signed by the current sender to ensue that the receiver can trust all the internal SignedData objects by verifying the signature of all the data. After the determination that the message requires further transmission 49, the message packet is sent to the next entity and the protocol starts over in step 43.

The information from each entity during the transmission is kept in the final SignedData object. From this final SignedData object, one can trace all events in the transmission. For example, if the final recipient receives a message with the three SignedData objects, the recipient can verify the authenticity and integrity of the three SignedData objects since they would have been received within an encompassing SignedData object. The final recipient can determine the chains of messages by linking together the related message digest signed attribute value within one SignedData to a message digest signed attribute value of another SignedData object. (The first message will typically have the same related message digest and message digest signed attribute values). The recipient can check the authenticity and integrity of each SignedData object by verifying the certificate and using the certificate's public key to verify the signature of the message. From the chain of messages, the final recipient can understand how the message was changed each step of the way. Lastly, the final recipient knows the initial sender's certificate and thus can immediately contact the initial sender through a signed and/or encrypted mechanism, if required.

For security the SignedData or grouped SignedData objects are transmitted using the confidentiality technologies provided by SSL, namely encryption and decryption using the established secret key.

The asynchronous case is similar in that it uses SignedData or multiple SignedData object wrapped within an EnvelopedData object that is sent via S/MIME. The EnvelopedData object provides confidentiality by using a unique secret key to encrypt the message. The secret key is encrypted by the recipient's public key. Only the recipient with the associated private key can decrypt the encrypted secret key and thus use the secret key to decrypt the message. The recipient can verify the encompassing SignedData object and each of the contained SignedData objects as before.

The different solutions can be mixed during the course of a sealed transaction. For example, the transaction may start between a client and server with a synchronous protocol, such as SSL, and be sent from the server to the final client recipient using an asynchronous protocol, such as S/MIME. An example of this would be someone creating multiple messages from an applet and sending the messages to a server via SSL. The server would then fax the messages using S/MIME to different fax servers related to fax machines that may or may not be immediately available.

The present invention provides advantages over the current message transmission protocols. Today the computing environment is more complex where operations and tasks are done either synchronously or asynchronously. During a message transaction, the data is disassembled and reassembled in order to transmit the data across the different communication types. The present invention provides a mechanism that accommodates both synchronous and asynchronous communication types and therefore eliminates the need to disassemble and reassemble data during a transmission across multiple communication types. In addition, the present invention allows any number of entities to participate in a sealed transaction, where each entity can add to the transaction. The complete transaction is protected from unintended recipients, and authentication and integrity is ensured with each entity. This also creates a record of events that occur during the transmission of information from a sender to a final destination. This record can show all transactions that occurred and all modifications to the message content. This record will assist in preserving the authenticity and integrity of the message during the transmission.

It is important to note that while the present invention has been described in the context of a fully functioning data processing system, those skilled in the art will appreciate that the processes of the present invention are capable of being distributed in the form of instructions in a computer readable medium and a variety of other forms, regardless of the particular type of medium used to carry out the distribution. Examples of computer readable media include media such as EPROM, ROM, tape, paper, floppy disc, hard disk drive, RAM, and CD-ROMs and transmission-type of media, such as digital and analog communications links.

Having thus described the invention, what we claim as new and desire to secure by Letters Patent is set forth in the following claims.

1. A general communication transmission method that enables a transmitted message to span synchronous and asynchronous protocols over a computer network during one transmission comprising:
packaging a message for transmission in a data object, the message packages including information on the original message in the transmission;
sending the packaged message to a designated recipient entity;
receiving the message by a current recipient entity at a location;
modifying packaged message information by current recipient entity to indicate that current recipient entity received the packaged message; and
determining whether current recipient entity is the designated recipient entity.

2. The method as described in claim 1 wherein said modification step further comprises adding substantive information to said packaged message.

3. The method as described in claim 1 wherein said message package is a data object with data fields containing the original message, signing certificate, signature bytes and signed attributes and wherein modification of the message package comprises creating a new data object that is added to the original data object, the new data object having additional information concerning the transmission.

4. The method as described in claim 1 wherein each recipient entity uses a public key and private key pair to authenticate the packaged message origin and contents.

5. The method as described in claim 4 further comprising verifying the packaged message by a recipient entity using the sending entities public key.

6. The method as described in claim 1 wherein said step of determining whether current recipient entity is the designated recipient entity comprises determining whether the packaged message received by said recipient entity has an existing message.

7. A system for transmitting messages spanning synchronous and asynchronous protocols over a computer network comprising:
a network transmission mechanism that enables transmissions across synchronous and asynchronous protocols;
a data structure for containing the information message transmitted over the computer network, the data structure having multiple fields for containing various items related to the message being transmitted; and
encryption key pairs to ensure authenticity and integrity of the message during transmission between sender and final receiver sites.

8. The system as described in claim 7 wherein said data structure contain information comprising original message, signing certificate, signature bytes and signed attributes.

9. The system as described in claim 7 further comprising additional data structures that can be linked and thereby added to the data structure of the original message at each receipt of the message during transmission, said additional data structures containing information about the message transmission.

10. A computer program product in a computer readable medium for use in transmitting messages that span synchronous and asynchronous protocols over a computer network during one transmission comprising:
instructions for packaging a message for transmission in a data object, the message packages including information on the original message in the transmission;
instructions for sending the packaged message to a designated recipient entity;
instructions for receiving the message by a current recipient entity at a location;
instructions for modifying packaged message information by current recipient entity to indicate that current recipient entity received the packaged message; and
instructions for determining whether current recipient entity is the designated recipient entity.

11. The computer program product as described in claim 10 wherein said instructions for modifying packaged messages further comprises instructions for adding substantive information to said packaged message.

12. The computer program product as described in claim 10 wherein said message package is a data object with data fields containing the original message, signing certificate, signature bytes and signed attributes and wherein said instructions for modifying the message package comprises creating a new data object that is added to the original data object, the new data object having additional information concerning the transmission.

13. The computer program product as described in claim 10 further comprising instructions for using a public key and private key pair to authenticate the packaged message origin and contents.

14. The computer program product as described in claim 13 further comprising verifying the packaged message by a recipient entity using the sending entities public key.

15. The computer program product as described in claim 10 wherein said instructions for determining whether current recipient entity is the designated recipient entity comprises instructions for determining whether the packaged message received by said recipient entity has an existing message.

16. A computer connectable to a distributed computing environment and including a mechanism for transmitting messages spanning synchronous and asynchronous protocols over a computer network comprising:
a processor;
a native operating system;
a network transmission mechanism that enables transmissions across synchronous and asynchronous protocols;
a data structure for containing the information message transmitted over the computer network, the data structure having multiple fields for containing various items related to the message being transmitted; and
encryption key pairs to ensure authenticity and integrity of the message during transmission between sender and final receiver sites.

17. The computer as described in claim 16 wherein said data structure contains information comprising original message, signing certificate, signature bytes and signed attributes.

18. The computer as described in claim 16 further comprising a means for linking additional data structures to the data structure of the original message at each receipt of the message during transmission, said additional data structures containing information about the message transmission at each receipt.
